(19) United States
(12) Patent Application Publication
(10) Pub. No.: US 2025/0258046 A1
(43) Pub. Date: Aug. 14, 2025

(54) TEMPERATURE SENSING UNIT

(71) Applicant: BRASCABOS COMPONENTES ELÉTRICOS E ELETRÔNICOS LTDA., Rio Claro (BR)

(72) Inventors: MARCOS PAULO MARTINS DE AZARA, Rio Claro (BR); FRANCISCO GONÇALVES DE AZEVEDO NETO, Rio Claro (BR); ROGÉRIO CANUTA DOS SANTOS, Rio Claro (BR); ALEXANDRE APARECIDO BREDA, Rio Claro (BR)

(73) Assignee: BRASCABOS COMPONENTES ELÉTRICOS E ELETRÔNICOS LTDA., Rio Claro (BR)

(21) Appl. No.: 19/048,247

(22) Filed: Feb. 7, 2025

(30) Foreign Application Priority Data
Feb. 9, 2024 (BR) 1020240027485

(51) Int. Cl. G01K 13/02

(52) U.S. Cl. CPC G01K 13/026

(57) ABSTRACT

A temperature sensor unit include a capsule and an assembly defined by a separating element and a sensor element, which is housed and retained, by resin, inside the capsule which is provided, at an open end, with a radial guide and, in its interior, with a longitudinal guide, the separating element incorporating laterally a longitudinal guide follower element which carries a radial guide follower element and which is slidably fitted, in the longitudinal guide, until the radial guide follower element is seated on the radial guide, defining the axial and rotational positioning of the sensor element inside the capsule.

### CROSS-REFERENCE TO RELATED APPLICATIONS

This application claims priority under 35 USC 119 to Brazilian Patent Application No. 10 2024 002748 5 filed Feb. 9, 2024, the entire contents of which are incorporated herein by reference.

### TECHNICAL FIELD

The present disclosure refers to a temperature sensing unit provided with an encapsulated sensing element, defined by a negative temperature coefficient thermistor (NTC), and to be used in different equipment, particularly in those for domestic use, such as, for example, refrigeration equipment defined by refrigerators, freezers, water coolers or other equipment such as washing machines or dishwashers, to measure the temperature of a process fluid, which can be defined by ambient air or by a liquid.

### BACKGROUND

It is well-known from the state of the art a construction of a temperature sensor unit comprising a tubular-shaped capsule, formed in non-electrically conductive polymeric material, such as PS or PVC, having a closed end, to be kept in contact with the process fluid to have its temperature monitored, and an open end, to allow a sensor element, defined by an NTC and incorporating its pair of contact terminals, to be positioned, with the help of a contact terminal separating element, inside the capsule and, subsequently, fixed inside the capsule by means of the injection and curing of a filler, generally defined by epoxy resin.

In the type of construction of the temperature sensor unit as discussed above, the sensor element is mounted and retained in a predetermined position in the separating element, with the positioning, in the radial direction, of the sensor element inside the capsule being guaranteed, therefore, by the dimensioning of the internal cross-section of the separating element in relation to the internal cross-section of the capsule. The relative radial movements between the separating element and the capsule are practically zero, and are not capable of producing distortions and/or variations in the reading of the sensor element, and of leading to losses of performance or even malfunction of the equipment in which the sensor element is applied.

However, in the constructive solution mentioned above, the positioning, in the axial and rotational directions, of the separating element and, consequently, of the sensor element inside the capsule, is guaranteed only by the ability of the operator when introducing the separating element/sensor element assembly in a rotational position and at a depth precisely predetermined according to the operational design of the equipment.

Assemblies with depth and angular positioning, out of the established standard, may be easily imperceptible, allowing the temperature sensor unit is considered as properly produced after injection and curing of the filling resin inside the capsule. In this case, the dysfunctional problem of the sensor unit will be detected late when it is installed in the target equipment.

As above mentioned, although the well-known temperature sensor unit described above is of simple construction and of easy production, it has the disadvantage of allowing, due to an inadvertent error by the assembly operator, the sensor element to be axial and/or rotationally mounted inside the capsule, outside the design position in sufficient degree to render the sensor unit deficient or even useless for its intended purpose, without the assembly imperfection being noticed before the unit is applied to the target equipment.

In addition to the risk of assembly error mentioned above, the well-known sensor unit also requires special care from the operator when positioning the capsule to receive the automatized injection of resin and even when manually assembling the sensor unit in certain target equipment. In this known solution and in those described in documents EP2166326B1 and CN103123282A, there are no techniques provided to prevent assembly errors by the operator.

### SUMMARY

Due to the limitations and drawbacks mentioned above and related to the lack of techniques to prevent incorrect assembly of both the sensor element inside the capsule and of the latter during the automatized receiving phase of the filling resin in the capsule, the present disclosure aims to provide a temperature sensor unit, in which the separating element/sensor element assembly has its manual assembly, guided inside the capsule, to desired axial and rotational design positions, which positions that, if not correctly achieved, are not only readily and visually detectable and correctable, by the assembly operator himself, but also by devices for verifying the correct relative positioning between the separating element/sensor element assembly and the capsule, after filling the latter with the resin for fixing the separating element/sensor element assembly.

The construction of the sensor unit has also the additional objective of providing the guided manual positioning of the capsule in a support mean, when fixing the separating element/sensor element assembly inside the capsule by filling the latter with curable resin.

### BRIEF DESCRIPTION OF THE DRAWINGS

The present disclosure will be described below, making references to the attached drawings, in which:

FIG. 1 represents a perspective view of a tubular-shaped capsule constructed in accordance with the present disclosure and when viewed from its open end;

FIG. 2 represents a diametrical cross-sectional view of the capsule, when taken according to line II-II in FIG. 1;

FIG. 3 represents a rear elevation view of a separating element constructed according to the present disclosure and also separated from the sensor element;

FIG. 4 represents a side elevation view of the separating element illustrated in FIG. 3;

FIG. 5 represents a top plan view of the separating element illustrated in FIG. 3;

FIG. 6 represents a longitudinal sectional view of the separating element, taken according to line VI-VI in FIGS. 4 and 5 and with the separating element already mounted to a sensor element which comprises a sensor NTC incorporating a pair of elongated terminals, each being connected to a respective length of conductive cable;

FIG. 7 represents a diametrical cross-sectional view of the capsule, when taken according to line II-II in FIG. 1, but housing, in its interior and in a side elevation view, the assembly formed by the separating element and the sensor element; and

FIG. 8 represents a top plan view of the assembly illustrated in FIG. 7.

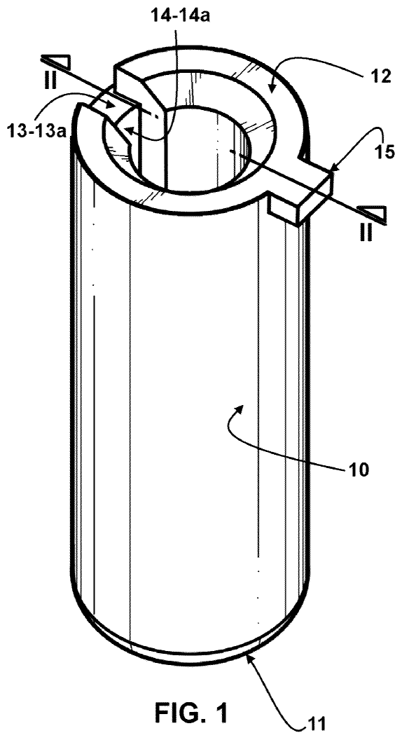

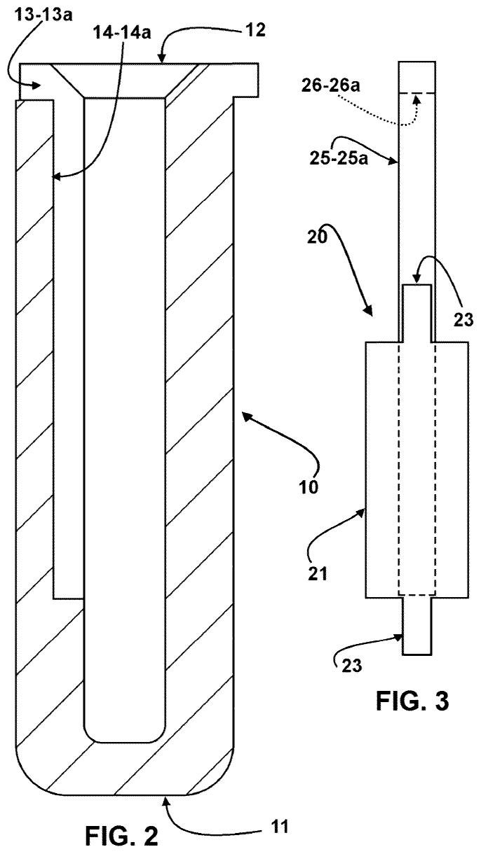

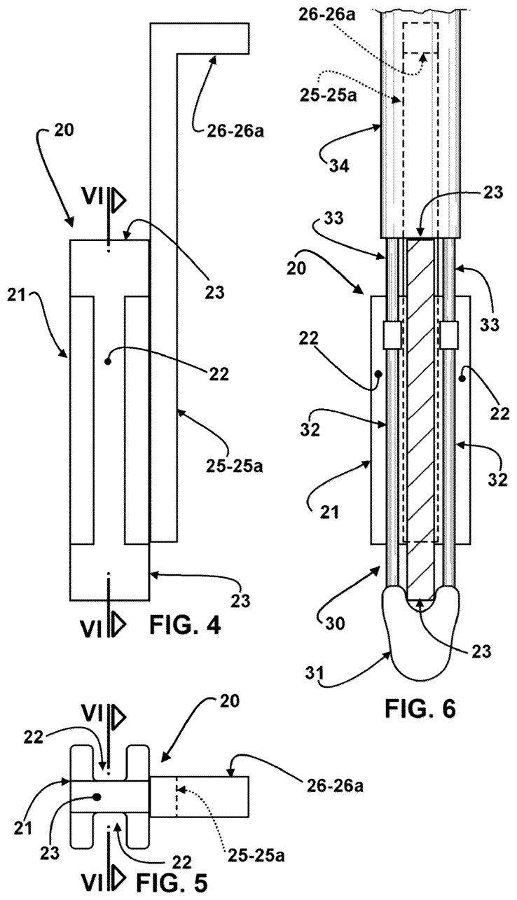

### DETAILED DESCRIPTION

As already mentioned and illustrated in the attached drawings, the temperature sensor unit UST is of the type that comprises a tubular capsule 10, formed in polymeric material such as PS or PVC, having a closed end 11, to be kept in contact with the process fluid to have its temperature monitored, and an open end 12, so that inside it can be mounted and subsequently retained an assembly defined by a separating element 20, in non-electrically conductive polymeric material, such as PS, in which is mounted a sensor element 30 formed by a sensor 31, defined by a negative temperature coefficient thermistor (NTC), and incorporating a pair of contact terminals 32, elongated and to be connected to respective extensions of conductive cables 33 joined in a single coated cable 34.

The separating element 20 has its body 21 presenting a median portion with a cross-section in the shape of an “H”, defining two opposing longitudinal grooves 22 in which the contact terminals 32 of the sensor element 30 and part of the conductive cable 33 are housed. The central web of the body 21 extends axially, in opposite directions, into extreme axial tabs 23, one of which is seated against the sensor 31, when the sensor element 30 is assembled in the separating element 20, in a known construction arrangement.

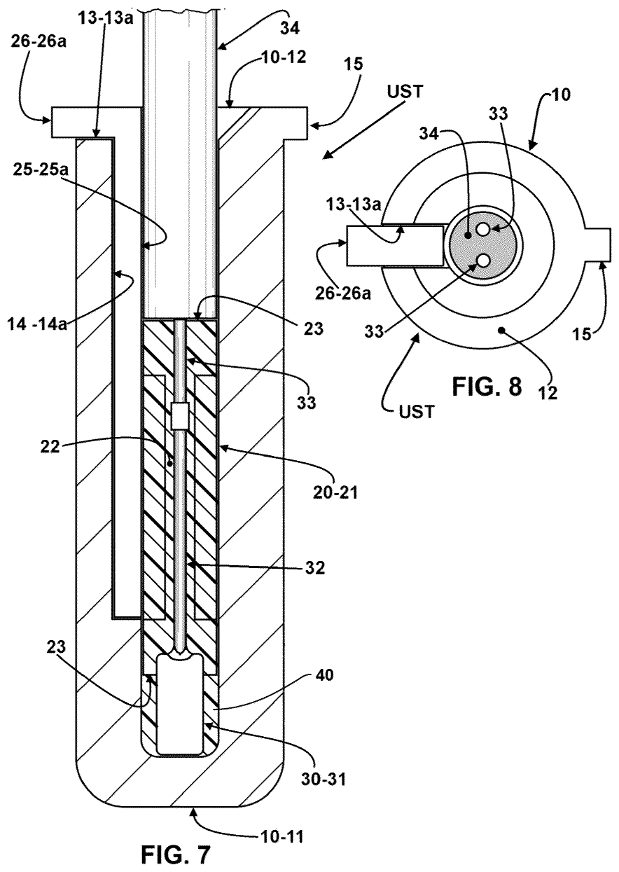

As can be seen from the accompanying drawings, the sensor element 30 is mounted to the separating element 20 and housed therewith, in a radially tight manner, and retained, by filling of curable resin 40 (shown in FIG. 7), inside the capsule 10.

According to the present disclosure, the capsule 10 is provided, at its open end 12, with a radial guide 13 and, in its interior, with a longitudinal guide 14 defined between the open end 12 and the closed end 11 of the capsule 10, with the separating element 20 incorporating, laterally and generally in a single piece, so as not to interfere with the contact terminals 32 and with the conductive cables 33 of the sensor element 30, a longitudinal guide follower element 25 that carries a radial guide follower element 26 in a position axially displaced with respect to the separating element 20.

In the above-mentioned construction, the longitudinal guide follower element 25 is slidably fitted into the longitudinal guide 14 of the capsule 10, together with the separating element 20 already carrying the sensor element 30, until the radial guide follower element 26 is seated in the radial guide 13, defining the axial and rotational positioning of the sensor element 30, already previously mounted on the separating element 20, inside the capsule 10.

In the constructive form illustrated in the drawings, the radial guide 13 is now defined by a radial groove 13a and the longitudinal guide 14 is now defined by an internal longitudinal groove 14a, which extends through the interior of the capsule 10, from the radial guide 13 and towards the closed end 11, in some embodiments, without reaching the latter, the longitudinal guide follower element 25 being defined by a positioning rod 25a which carries, at a free end, the radial guide follower element 26, in some embodiments, is defined by a radial tab 26a. With this, the positioning rod 25a can be slidably fitted into the internal longitudinal groove 14a of the capsule 10 until the radial guide follower element 26 is seated in the radial guide 13, defining the axial and rotational positioning of the sensor element 30 inside the capsule 10.

The above-defined construction arrangement allows, with different configurations for the guides and guide follower elements, that the longitudinal guide follower element 25 can be slidably fitted into the longitudinal guide 14 of the capsule 10, from the open end 12 of the latter, until the radial guide follower element 26, which can take the form of a radial tab 26a, is seated in the radial guide 13, which can take the form of a radial groove 13a, defining the precise axial and rotational positioning of the sensor element 30 inside the capsule 10, independently of the ability of the manual movement performed by the assembly operator.

In addition to ensuring the correct axial and rotational positioning of the sensor element 30 inside the capsule 10, the present solution induces the operator to correctly assemble the sensor element 30, with the separating element 20, inside the capsule 10, also facilitating to the operator an easy visualization of eventual deviations in relative positioning when the radial tab 26a does not fit or is not completely seated in the radial groove 13a at the open end of the capsule 10.

If the incorrect assembly of the sensor element 30 is not noticed by the operator, the radial tab 26a may have a measuring face, opposite to that of seating in the radial groove 13a, capable of having the level of its plane, in relation to the plane of the open end 12 of the capsule 10, after the manual assembly operation is finished, checked by a mechanical or optical equipment (not illustrated), preventing that eventual temperature sensor units, having the sensor element 30 not correctly positioned inside the capsule 10, are unduly considered suitable for assembly in the equipment for which they are intended.

To facilitate the detection of possible assembly deviations that indicate improper positioning of the separating element 20 and sensor element 30 assembly inside the capsule 10, the radial groove 13a has its end radially external, opposite to that open to the interior of the longitudinal groove 14a, open to the exterior of the capsule 10, allowing the radial tab 26a of the positioning rod 25a to project radially outwards from the capsule 10, when it is seated in the radial groove 13a.

As previously mentioned, the retention of the assembly defined by the separating element 20 and the sensor element 30, inside the capsule 10, is usually carried out by filling the latter with a curable resin 40, generally an epoxy resin, with the application of the resin 40 being carried out, by robotic devices, with a plurality of capsules 10 fitted into cavities provided in a support, for example a plate.

In order to obtain a correct automatized and progressive filling of the capsules 10 with resin 40, the capsules 10 must be correctly fitted into the respective cavities of the support, at a level predetermined for the operation designed for the robotic device of filling the capsules 10 with resin 40.

In order to prevent errors resulting from incorrect or incomplete manual assembly of the capsules 10 in the cavities of the support, for carrying out the filling operation with resin 40, the capsule 10 incorporates, at its open end 12, at least one external radial projection 15, angularly offset in relation to the radial groove 13a and which defines an mounting stop, to be seated against a portion of the surface of the support defined around each receiving cavity for a capsule 10.

The provision of the external radial projection 15 at the open end 12 of the capsule 10 may further operate as a mounting stop of the temperature sensor unit UST in a respective housing of the equipment for which it is intended.

It is claimed:

1. A temperature sensor unit comprising:
a tubular and non-electrically conductive capsule, having a closed end and an open end;
a non-electrically conductive separating element; and
a sensor element mounted on the separating element and formed by a sensor and by a pair of contact terminals with respective extensions of conductive cables,
wherein the sensor element is mounted on the separating element and housed therewith, in a radially tight manner, and retained by resin filling an interior of the capsule,
wherein the capsule is provided, at the open end, with a radial guide and, in the interior, with a longitudinal guide defined between the open end and the closed end,
wherein the separating element incorporates laterally a longitudinal guide follower element that carries a radial guide follower element in a position axially displaced in relation to the separating element, the longitudinal guide follower element being slidably fitted into the longitudinal guide of the capsule, together with the separating element, until the radial guide follower element is seated in the radial guide.

2. The temperature sensor unit according to claim 1, wherein the radial guide is defined by a radial groove and the longitudinal guide is defined by an internal longitudinal groove, which extends through the interior of the capsule, from the radial guide and towards the closed end,
wherein the longitudinal guide follower element is defined by a positioning rod which carries, at a free end, the radial guide follower element defined by a radial tab,
wherein the positioning rod is slidably fitted into the internal longitudinal groove of the capsule until the radial guide follower element is seated in the radial guide, defining an axial and rotational positioning of the sensor element inside the capsule.

3. The temperature sensor unit according to claim 2, wherein the radial groove has an end, opposite to that open towards the interior of the longitudinal groove, open towards the exterior of the capsule.

4. The temperature sensor unit according to claim 3, wherein the radial tab of the positioning rod projects radially outwards from the capsule, when the radial tab is seated in the radial groove.

5. The temperature sensor unit according to claim 1, wherein the capsule incorporates, at its open end, at least one external radial projection, angularly offset in relation to the radial guide and which defines a mounting stop of the capsule.

6. The temperature sensor unit according to claim 2, wherein the capsule incorporates, at the open end, at least one external radial projection, angularly offset in relation to the radial guide and which defines a mounting stop of the capsule.

7. The temperature sensor unit according to claim 3, wherein the capsule incorporates, at the open end, at least one external radial projection, angularly offset in relation to the radial guide and which defines a mounting stop of the capsule.

8. The temperature sensor unit according to claim 4, wherein the capsule incorporates, at the open end, at least one external radial projection, angularly offset in relation to the radial guide and which defines a mounting stop of the capsule.

9. The temperature sensor unit according to claim 1, wherein the separating element incorporates the longitudinal guide follower element in a single piece.

10. The temperature sensor unit according to claim 2, wherein the separating element incorporates the longitudinal guide follower element in a single piece.

11. The temperature sensor unit according to claim 3, wherein the separating element incorporates the longitudinal guide follower element in a single piece.

12. The temperature sensor unit according to claim 4, wherein the separating element incorporates the longitudinal guide follower element in a single piece.

13. The temperature sensor unit according to claim 5, wherein the separating element incorporates the longitudinal guide follower element in a single piece.

14. The temperature sensor unit according to claim 1, wherein the sensor is defined by a NTC.

15. The temperature sensor unit according to claim 2, wherein the sensor is defined by a NTC.

16. The temperature sensor unit according to claim 3, wherein the sensor is defined by a NTC.

17. The temperature sensor unit according to claim 4, wherein the sensor is defined by a NTC.

18. The temperature sensor unit according to claim 5, wherein the sensor is defined by a NTC.

19. The temperature sensor unit according to claim 6, wherein the sensor is defined by a NTC.
